(19) United States
(12) Patent Application Publication
(10) Pub. No.: US 2026/0359362 A1
(43) Pub. Date: Nov. 12, 2026

(54) CONTEXT-DRIVEN INTERACTIVE DISAMBIGUATION FOR QUESTION ANSWERING SYSTEMS

(71) Applicant: Palo Alto Networks, Inc., Santa Clara, CA (US)

(72) Inventors: Tejul Mayank Pandit, Santa Clara, CA (US); Sakshi Mahendru, Santa Clara, CA (US); Alina Asish Rath, San Jose, CA (US); Ramanathan Lakshmikanthan, Santa Clara, CA (US)

(21) Appl. No.: 19/670,717

(22) Filed: May 7, 2026

Related U.S. Application Data
(60) Provisional application No. 63/801,760, filed on May 7, 2025.

(51) Int. Cl. G06F 16/9032; G06F 16/93; G06F 40/40; G06N 3/042

(52) U.S. Cl. CPC G06F 16/90332; G06F 16/93; G06F 40/40; G06N 3/042

(57) ABSTRACT

Systems and methods are disclosed for improving automated question answering systems by dynamically disambiguating user queries using document-aware reasoning and iterative clarification. A computing system receives a user query and retrieves relevant documents. Query vagueness is determined based on one or more ambiguity signals, and a large language model evaluates whether the query requires disambiguation in view of the vagueness and retrieved documents. When disambiguation is required, the system retrieves documents from both a general knowledge base and a solution repository. If no solution-repository document satisfies a relevancy criterion, the system clusters documents from the general knowledge base, generates thematic summaries for the clusters, and selects one or more clusters relevant to the query. Based on the selected cluster, a follow-up question is generated to clarify user intent, and a user response is received. The original query and the user response are integrated to generate an enriched query, which is used to invoke a response generation pipeline that retrieves contextual information and generates a final response grounded in the clarified intent.

### TECHNICAL FIELD

The present disclosure relates generally to a generative question answering system.

### BACKGROUND

Artificial intelligence-based question answering (QA) systems are increasingly used to provide users with information across a wide range of applications, including enterprise knowledge management, customer support, research assistance, and general information retrieval. These systems aim to interpret natural-language queries and generate responses that are accurate, relevant, and contextually appropriate.

Generative question answering systems represent an advancement over traditional extractive approaches. Rather than identifying and returning exact text excerpts from source documents, generative QA systems synthesize novel responses using machine learning models, such as large language models (LLM).

A generative LLM operating alone produces responses based solely on patterns learned during training and lacks direct access to authoritative, up-to-date, or domain-specific information at inference time. As a result, an LLM-only system may generate fluent but incomplete, overly generic, or factually incorrect answers, particularly when a query requires precise facts, enterprise data, or current knowledge. Retrieval-Augmented Generation (RAG) and similar techniques addresses this limitation by incorporating a retrieval step that identifies relevant documents or data from external knowledge sources and supplies that material as context to the generative model, thereby grounding the response in concrete evidence. Without such retrieval, the generative response may not reliably satisfy many real-world information needs, as accuracy and relevance are constrained by the model's static internal knowledge rather than the contents of the underlying information repository.

While RAG architectures improve factual grounding and reduce unsupported generation, they remain highly sensitive to the content and structure of the user's query. In particular, these systems struggle when queries lack sufficient detail, include vague terminology, or are ambiguous with respect to the user's underlying intent. When faced with such queries, the retrieval component may surface documents that are only partially relevant or entirely unrelated, thereby constraining the generative model to produce an answer that is inaccurate, incomplete, or not responsive to the user's actual information need.

Ambiguity in a user query presents a substantial technical difficulty because a single query string may correspond to multiple plausible interpretations. These interpretations can imply different domains, entities, timeframes, or problem scopes, each of which would require different retrieval behavior and different answers. Existing QA systems typically proceed under an implicit assumption of a single intended meaning. If that assumption is incorrect, the resulting output may be misleading, overly generic, or otherwise non-useful, despite the system functioning as designed.

In retrieval-augmented systems, ambiguity is particularly problematic because errors introduced at the query interpretation stage tend to propagate through downstream components. An underspecified or ambiguous query can lead to low-quality query representations, ineffective retrieval, and the exclusion of critical information from the context provided to the generative model. Since the accuracy of the generated answer is bounded by the relevance of the retrieved materials, deficiencies in query understanding can have a compounding negative effect on system performance.

Accordingly, there is a need for improved AI-based question answering systems capable of recognizing when a user query is ambiguous or lacks sufficient context and of addressing such deficiencies in a more robust and intent-aware manner. Addressing these technical challenges would improve retrieval accuracy, enhance the relevance of generated responses, and increase the overall reliability and effectiveness of generative QA systems operating over large-scale knowledge bases.

### SUMMARY OF PARTICULAR EMBODIMENTS

Embodiments described herein outline a QA system designed for query disambiguation, leveraging external context and guided user interaction to clarify intent and improve the precision of the QA process. Experiments with these embodiments have demonstrated a 55% efficacy improvement (Efficacy improved from ~55% to ~85%) and a 30% reduction in Time To Resolve (TTR) queries.

At a high-level, a QA system designed according to the present disclosure identifies potentially vague user queries after initial retrieval and relevance checking. Based on specific criteria (e.g., query length, lack of specific identifiers like error logs) identifying potentially vague queries, the QA system triggers a disambiguation workflow. This workflow involves targeted retrieval from distinct sources (e.g., general documents and specialized playbooks), context analysis using document clustering and LLM-based summarization, and the generation of targeted follow-up questions to solicit clarifying information from the user. The goal is to refine the user's vague query through this interactive process, leading to significantly improved retrieval accuracy and more relevant final answers, particularly for complex or underspecified information needs.

The clauses below summarize various embodiments described herein.

Example Clause A: A method may include, by a computing system: receiving a query from a user; retrieving relevant documents to the query; determining a query vagueness of the query based on one or more ambiguity signals; determining, by a large language model, whether the query requires disambiguation based on the query vagueness and the relevant documents; in response to determining that the query requires disambiguation, retrieving, based on the query, (i) a set of first documents from a general knowledge base and (ii) a set of second documents from a solution repository; determining whether any second document in the set of second documents satisfies a relevancy criterion for the query; in response to a determination that the set of second documents fails to satisfy the relevancy criterion, determining clusters of first documents from the set of first documents; generating a thematic summarization of each of the clusters of first documents; selecting at least one cluster from the clusters of first documents based on the thematic summarization of the cluster; generating, based on the at least one cluster, a follow-up question configured to clarify the query; receiving a response to the follow-up question from the user; generating an enriched query based on the query and the response to the follow-up question; and invoking a response generation pipeline that retrieves contextual information using the enriched query and generates a final response to the query based on the retrieved contextual information.

Example Clause B: The method of Example Clause A, where each of the relevant documents is retrieved based on pre-computed embeddings of questions associated with the relevant document, the pre-computed embeddings being generated prior to receiving the query from the user.

Example Clause C: The method of Example Clause A or Example Clause B, where the one or more ambiguity signals are determined based on at least one of a query length or absence of domain-specific identifiers.

Example Clause D: The method of any one of Example Clauses A-C, where the retrieving of the relevant documents and the determining of the query vagueness are tools invoked by the large language model in response to the query.

Example Clause E: The method of any one of Example Clauses A-D, where the solution repository may include documents describing end-to-end troubleshooting guidance.

Example Clause F: The method of any one of Example Clauses A-E, where each document in the (i) set of first documents and (ii) the set of second documents is retrieved based on pre-computed embeddings of questions associated with that document, the pre-computed embeddings being generated prior to receiving the query from the user.

Example Clause G: The method of any one of Example Clauses A-F, where the clusters of first documents are determined based on pre-computed embeddings associated with the set of first documents.

Example Clause H: The method of any one of Example Clauses A-G, where generating the thematic summarization of each cluster in the clusters of first documents may include: identifying segments in the first documents in the cluster that are relevant to the query; and generating the thematic summarization based on the segments.

Example Clause I: The method of any one of Example Clauses A-H, where generating the follow-up question may include: selecting at least one first document in the at least one cluster; and invoking the large language model to generate the follow-up question based on at least (i) segments in the at least one first document that are relevant to the query, (ii) predetermined questions associated with the at least one first document, and (iii) the query.

Example Clause J: The method of any one of Example Clauses A-I, where the enriched query is generated using one or more additional responses to one or more corresponding follow-up questions accumulated over multiple interaction turns with the user.

Example Clause K: The method of any one of Example Clauses A-J, further may include limiting a number of follow-up question generation iterations to a predefined maximum.

Example Clause L: The method of any one of Example Clauses A-K, where the follow-up question is generated using the large language model instructed to perform a chain-of-thought operation.

Example Clause M: A method may include, by a computing system: receiving a query from a user; retrieving relevant documents to the query; determining a query vagueness of the query based on one or more ambiguity signals; determining, by a large language model, whether the query requires disambiguation based on the query vagueness and the relevant documents; in response to determining that the query requires disambiguation, retrieving, based on the query, (i) a set of first documents from a general knowledge base and (ii) a set of second documents from a solution repository; determining whether any second document in the set of second documents satisfies a relevancy criterion for the query; in response to a determination that a second document in the set of second documents satisfies the relevancy criterion, generating, based on the second document, a follow-up question configured to clarify the query; receiving a response to the follow-up question from the user; generating an enriched query based on the query and the response to the follow-up question; and invoking a response generation pipeline that retrieves contextual information using the enriched query and generates a final response to the query based on the retrieved contextual information.

Example Clause N: The method of Example Clause M, where each of the relevant documents is retrieved based on pre-computed embeddings of questions associated with the relevant document, the pre-computed embeddings being generated prior to receiving the query from the user.

Example Clause O: The method of Example Clause M or Example Clause N, where the one or more ambiguity signals are determined based on at least one of a query length or absence of domain-specific identifiers.

Example Clause P: The method of any one of Example Clauses M-O, where the solution repository may include documents describing end-to-end troubleshooting guidance.

Example Clause Q: A system may include: one or more processors; a memory storing instructions that, when executed by the one or more processors, cause the system to: receive a query from a user; retrieve relevant documents to the query; determine a query vagueness of the query based on one or more ambiguity signals; determine, by a large language model, whether the query requires disambiguation based on the query vagueness and the relevant documents; in response to a determination that the query requires disambiguation, retrieve, based on the query, (i) a set of first documents from a general knowledge base and (ii) a set of second documents from a solution repository; determine whether any second document in the set of second documents satisfies a relevancy criterion for the query; in response to a determination that the set of second documents fails to satisfy the relevancy criterion, determine clusters of first documents from the set of first documents; generate a thematic summarization of each of the clusters of first documents; select at least one cluster from the clusters of first documents based on the thematic summarization of the cluster; generate, based on the at least one cluster, a follow-up question configured to clarify the query; receive a response to the follow-up question from the user; generate an enriched query based on the query and the response to the follow-up question; and invoke a response generation pipeline that retrieves contextual information using the enriched query and generates a final response to the query based on the retrieved contextual information.

Example Clause R: The system of Example Clause Q, where each document in (i) the set of first documents and (ii) the set of second documents is retrieved based on pre-computed embeddings of questions associated with that document, the pre-computed embeddings being generated prior to receiving the query from the user.

Example Clause S: The system of Example Clause Q or Example Clause R, where the instructions, when executed by the one or more processors, are configured to cause the system to generate the thematic summarization of each cluster in the clusters of first documents by: identifying segments in the first documents in the cluster that are relevant to the query; and generating the thematic summarization based on the segments.

Example Clause T: The system of any one of Example Clauses Q-S, where the instructions, when executed by the one or more processors, are configured to cause the system to generate the follow-up question by: selecting at least one first document in the at least one cluster; and invoking the large language model to generate the follow-up question based on at least (i) segments in the at least one first document that are relevant to the query, (ii) predetermined questions associated with the at least one first document, and (iii) the query.

### BRIEF DESCRIPTION OF THE DRAWINGS

The embodiments will be described in greater detail below based on the exemplary figures. However, it should be noted that the concepts contemplated herein are not limited to the exemplary embodiments. Other features and advantages of various embodiments of the present invention will become apparent by reading the following detailed description with reference to the figures.

FIG. 1 illustrates an example system architecture for agentic query disambiguation in a question answering environment, according to particular embodiments.

FIG. 2 illustrates a flow diagram of an example computer-implemented method for query disambiguation and response generation.

FIG. 3 illustrates an example of a computer system that may be used in performing one or more of the foregoing techniques, according to particular embodiments.

### DETAILED DESCRIPTION OF EMBODIMENTS

Conventional question answering (QA) systems, including Retrieval-Augmented Generation (RAG) pipelines, encounter significant limitations when processing user queries that lack sufficient detail or are ambiguous with respect to user intent. Existing techniques, such as static query rephrasing or expansion, may offer incremental improvement in limited cases but generally fail when essential contextual information is missing or when multiple plausible interpretations of the query exist. Under such conditions, these systems frequently perform suboptimal retrieval, which in turn constrains the generative model and results in inaccurate, irrelevant, or misleading responses.

At the same time, not all user queries require additional clarification or enrichment. Many queries are sufficiently specific and can be accurately answered without further disambiguation. Indiscriminately attempting to enrich or clarify every query is undesirable, as it unnecessarily consumes computational resources, increases response latency, and risks introducing extraneous or misleading information that can degrade retrieval performance.

Conventional QA architectures typically operate as rigid, linear pipelines and lack the ability to dynamically determine whether a given query is clear, ambiguous, or fundamentally unanswerable given available information. As a result, existing systems are ill-equipped to selectively apply enrichment strategies only when warranted, or to manage ambiguity through targeted, context-aware interactions while avoiding redundant or unnecessary processing. There is therefore a need for a more flexible, agentic approach that can evaluate query sufficiency, conditionally engage in clarification or information-gathering actions, and maintain an evolving representation of conversational state across one or more interaction turns.

To address the technical challenges associated with ambiguous or underspecified user queries, embodiments described herein generate and present context-aware clarifying questions that are selectively invoked when disambiguation is warranted. The system analyzes the subject domain and potential semantic variations of an incoming query to determine whether the query lacks sufficient specificity or admits multiple plausible interpretations. When such conditions are detected, the system poses targeted follow-up questions designed to elicit the missing contextual information necessary to accurately capture the user's intent. By doing so, the system narrows the scope of subsequent information retrieval, reduces noise from irrelevant results, and enables the generation of more precise, intent-aligned responses.

In one or more embodiments, the invention introduces an Agentic Query Disambiguation System integrated into a Retrieval-Augmented Generation (RAG) workflow. The architecture is organized around an autonomous orchestrator that dynamically manages execution flow across multiple specialized tools rather than following a rigid, linear pipeline. This orchestrator evaluates the sufficiency of the query and determines whether additional clarification is required before final retrieval and answer generation.

At a high-level, particular embodiments of the disambiguation system employs an agentic reasoning loop to identify vague or ambiguous queries. Based on the combined output of a document relevancy checker and a vagueness detector, the orchestrator conditionally initiates a disambiguation workflow. This workflow may include parallel retrieval from general and specialized knowledge sources, clustering of retrieved documents to identify divergent interpretations, and large language model-based summarization to formulate concise, targeted clarifying questions. A persistent memory bank maintains conversational state across interaction turns, enabling context-aware multi-turn dialogue, preventing redundant clarification prompts, and progressively refining the user's intent into a high-precision query for final RAG execution.

A QA system designed according to the embodiments described herein can be applied in various contexts, such as assisting users with troubleshooting, diagnostics, or resolving issues. For instance, it could be used in a network security setting to help users identify the root cause or solution for problems in the network security domain. In such specific domains, the QA system may have access to a solution repository containing multiple documents detailing solutions to known problems in the domain. Thus, in particular embodiments, the QA system may be designed to leverage multiple retrieval sources—such as standard document retrieval and domain-specific document repositories—to gather contextual information. The contextual information may help the QA system refine the user's query and/or generate follow-up questions as needed.

Particular embodiments of the QA system described herein integrate a combination of processing steps, including knowledge base pre-processing, runtime relevance checks, vagueness detection, specialized retrieval strategies, context clustering, intelligent follow-up question generation, and multi-turn conversation handling. Each stage of the process is described in further detail below.

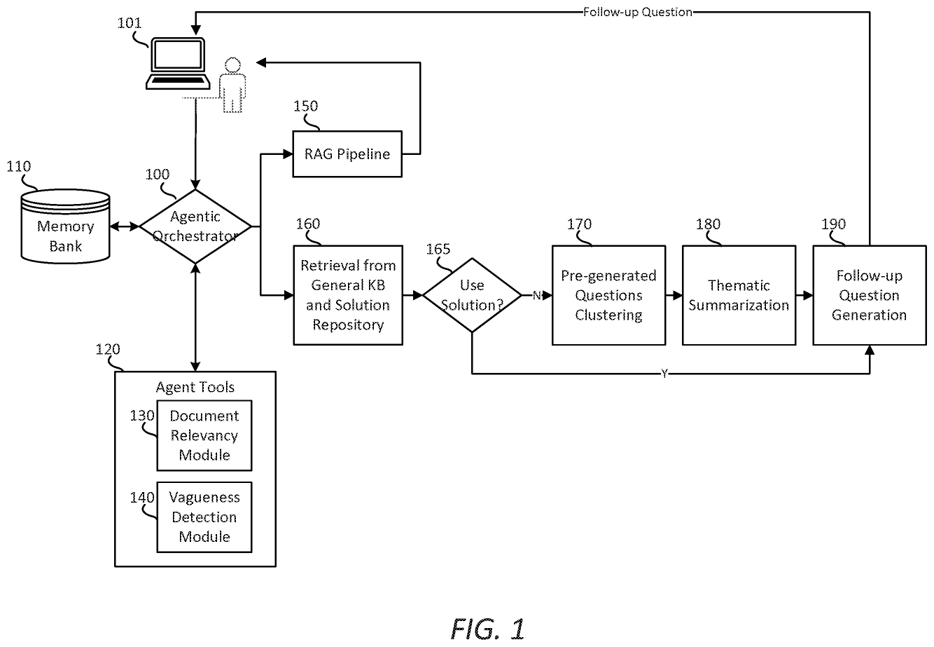

FIG. 1 illustrates an example system architecture for agentic query disambiguation in a question answering environment, according to particular embodiments. As shown, a user may interact with the system via a user device 101, such as a laptop computing device, mobile phone, tablet, or other network-enabled computing platform capable of transmitting and receiving data over one or more communication networks.

The user device 101 is communicatively coupled to an agent orchestrator 100, which operates as a central control component in the system. The agent orchestrator 100 is powered by one or more large language models (LLMs) and is responsible for interpreting user queries, reasoning about query sufficiency and ambiguity, and dynamically coordinating actions across a set of agent tools 120. In one embodiment, the agent orchestrator 100 functions as an autonomous, goal-directed agent that selects, sequences, and invokes tools 120 based on the content of the user query, system prompts, and/or intermediate analysis results.

The agent orchestrator 100 maintains access to the agent tools 120, which comprise modular software components providing specialized capabilities. In operation, the agent orchestrator 100 receives an initial query from the user device 101 and performs an agentic reasoning process using the LLM to assess the query. Based on this reasoning and other system prompt, the agent orchestrator 100 selectively invokes one or more of the agent tools 120. In some embodiments, the agent orchestrator 100 communicates with the agent tools 120 via a standardized agent-tool interface or protocol, such as a Model Context Protocol (MCP), which allows the orchestrator 100 to discover tool capabilities, input requirements, and output formats. Through such a protocol, the agent orchestrator 100 can dynamically determine which tools are available, request tool execution with specified parameters, and incorporate returned results into its ongoing reasoning process.

In particular embodiments, the agent tools 120 include at least a document relevancy module 130 and a vagueness detection module 140, although additional tools may be present in other embodiments. The document relevancy module 130 is configured to evaluate whether documents retrieved in response to a query are sufficiently relevant, coherent, or consistent with an inferred user intent. The vagueness detection module 140 is configured to analyze the user query and/or intermediate retrieval results to determine whether the query lacks sufficient specificity, contains ambiguous terms, or admits multiple plausible interpretations. Each of these tools will be described in further detail below.

In particular embodiments, the document relevancy module 130 is configured to access a knowledge base to retrieve and evaluate documents in view of a user's query. This functionality is needed because generative question answering systems, particularly those employing retrieval-augmented generation, rely on the quality and relevance of retrieved documents to constrain and ground generated responses. Without an explicit mechanism for evaluating document relevance, the system may retrieve an overly broad or noisy set of documents, which can degrade downstream reasoning, increase computational cost, and lead to inaccurate or misleading answers.

As used herein, a knowledge base refers to a collection of documents that the QA system references at runtime to determine context for, or generate an answer to, a user's query. In large-scale deployments, such knowledge bases may include thousands or millions of documents. Performing retrieval and relevance determination over such corpora at query time can be computationally expensive and time-consuming, particularly in applications requiring near real-time responses. For example, if generating a vector embedding for a document requires approximately two minutes of processing time, then embedding just 50 documents would require on the order of 100 minutes of computation. Such latency would render the QA system impractical for interactive use and would significantly impair user experience.

To address these performance constraints, certain embodiments perform a preprocessing step that enriches the knowledge base with metadata designed to support efficient runtime analysis. In this preprocessing phase, each document in the corpus is analyzed offline by an LLM using a prompt that instructs the LLM to identify and generate a set of specific questions that the document is capable of answering. These generated questions represent the semantic intent and informational scope of the document in a form that is more directly comparable to user queries.

For each generated question, a vector embedding is computed using a suitable embedding model, such as text-embedding-05 or text-embedding-ada-002, thereby representing the questions in an n-dimensional embedding space. The generated questions and/or their corresponding embeddings are stored as metadata in a datastore, with each question and/or embedding explicitly associated with its parent document. This preprocessing is performed prior to runtime operation and therefore does not introduce latency during user interaction.

In this embodiment, embeddings are generated for the questions that a document can answer rather than for the document content itself. By doing so, the system aligns the representation used for document retrieval with the semantic structure of user queries, which are themselves typically phrased as questions or requests for information. During runtime, a user's query is mapped into the same embedding space and compared against the precomputed question embeddings. Documents whose question embeddings are closest to the query embedding are identified as likely relevant, signaling that the document is capable of answering the user's query.

This embedding-to-embedding matching process enables the document relevancy module 130 to rapidly identify a focused subset of relevant documents without requiring expensive per-document analysis at query time. As a result, the system can significantly reduce latency while maintaining high retrieval precision, which is particularly important in real-time or interactive QA systems. The precomputed metadata—including the generated questions and their embeddings—thus enables efficient context analysis and query refinement, and supports downstream disambiguation and retrieval processes as described in further detail below.

During runtime, the document relevancy module 130 may leverage the precomputed question embeddings to efficiently evaluate document relevance. For example, in response to a user query, the QA system may first retrieve an initial set of candidate documents from the knowledge base using established retrieval techniques, such as vector similarity search. The document relevancy module 130 then determines the relevance of each candidate document by comparing an embedding of the user's query to the precomputed question embeddings associated with that document. Documents whose associated question embeddings are closer to the query embedding within a shared embedding space are deemed more relevant, as such proximity reflects greater semantic alignment between the information needs expressed in the user query and the questions the document is capable of answering. Conversely, documents whose embeddings are farther from the query embedding exhibit lower semantic alignment and are therefore considered less relevant or unlikely to contain information responsive to the user's query. In particular embodiments, each document may be assigned a relevance score based on the vector similarity comparisons. In particular implementations, documents with relevance scores above a certain predetermined threshold may be retained for further downstream processing, which will be described in further detail.

In certain embodiments, the document relevancy module 130 may supplement or replace embedding-based relevance determination with LLM-based natural-language evaluation. For example, embeddings may be used as a first-stage filter to retrieve a set of potentially relevant documents from the knowledge base. The system may then prompt an LLM to evaluate each of those document individually with respect to the user's query using natural-language reasoning. In response to the prompt, the LLM may assign a relevance score or classification to each document, such as “completely relevant,” “partially relevant,” or “not relevant.” The document relevancy module 130 filters the retrieved documents based on these scores or classifications, discarding documents identified as not relevant and retaining documents deemed sufficiently relevant. In particular embodiments, documents classified as completely relevant, and optionally those classified as partially relevant, are retained for downstream processing. This refinement step improves the quality of retrieved context for answer generation and also provides a valuable signal for detecting query vagueness, as described in further detail below.

Turning now to the vagueness detection module 140, which is configured to determine whether a user query lacks sufficient specificity to support accurate information retrieval and answer generation. The vagueness detection module 140 may employ one or more techniques to assess query vagueness, including rule-based heuristics, natural-language analysis, and/or contextual signals derived from system behavior.

In some embodiments, the vagueness detection module 140 applies heuristic-based criteria that capture common characteristics of vague queries. One such heuristic is query length. Queries that are relatively short often lack necessary contextual details, such as scope, entity identifiers, or problem descriptions, and therefore may be more likely to be ambiguous. Accordingly, the vagueness detection module 140 may compare the length of the user query to a configurable threshold (for example, fewer than ten or twenty words) and classify the query as potentially vague when the query falls below the threshold.

However, query length alone may be an overly inclusive indicator of vagueness in certain operational contexts. For example, in embodiments where the QA system supports domain-specific troubleshooting or technical support—such as network security, software diagnostics, or system administration—users may submit short but highly informative queries that include structured technical identifiers. These identifiers may include error codes, log entries, stack traces, alert identifiers, or other machine-generated diagnostic information. In such cases, even a short query may convey sufficient implicit context to enable accurate retrieval and response generation.

To address this, the vagueness detection module 140 may incorporate content-based exclusion criteria in addition to length-based heuristics. For instance, the module 140 may analyze the query to detect the presence of predefined patterns, tokens, or formats associated with technical identifiers, such as alphanumeric error codes or log signatures. If such identifiers are detected, the query may be classified as non-vague despite being short, on the basis that the identifiers provide sufficient contextual grounding for effective retrieval. In these scenarios, the query does not require further clarification and does not trigger a query disambiguation process. Conversely, if the query is short and lacks identifiable technical identifiers, the vagueness detection module 140 may determine that the query is vague.

The document relevancy module 130 and the vagueness detection module 140 may be used by the agentic orchestrator 100 at runtime to determine whether to invokes the disambiguation flow. In operation, upon receiving a user query from the user device 101, the agentic orchestrator 100 invokes a plurality of agent tools 120, including the document relevancy module 130 and the vagueness detection module 140, to evaluate whether disambiguation of the user query is needed. In particular embodiments, these modules may be invoked in parallel. These modules may be intentionally decoupled and execute independently, allowing their outputs to be jointly evaluated by the agentic orchestrator 100 rather than processed through a fixed, sequential pipeline.

The document relevancy module 130 may evaluate whether one or more documents in the knowledge base are relevant to the user query. As previously described, the document relevancy module 130 may identify a list of documents that has met the relevancy threshold or criteria, if any, and return them to the agentic orchestrator 100.

The vagueness detection module 140 analyzes the user query to determine whether the query lacks sufficient specificity or admits multiple plausible interpretations. In some embodiments, this vagueness determination may be expressed as a Boolean output or as a graded confidence score reflecting a degree of vagueness, and may be derived from a combination of heuristic analysis and LLM-based reasoning.

Upon receiving outputs from the document relevancy module 130 and the vagueness detection module 140, the agentic orchestrator 100 performs a reasoning process, guided by system instructions or prompts, to determine which processing flow to trigger. For example, the agentic orchestrator 100 may evaluate the relevant documents identified by the document relevancy module 130 and the vagueness determination by the vagueness detection module 140 to determine whether disambiguation is needed.

In particular embodiments, the agentic orchestrator 100 is instructed to prioritize the output of the vagueness detection module 140, such that a determination that the query is vague supersedes other considerations. This prioritization reflects the recognition that the existence of apparently relevant documents does not necessarily indicate that the user's intent has been sufficiently captured. For example, a query containing broadly used or ambiguous terms may semantically match a large number of documents, yet still omit critical details required to accurately resolve the user's underlying information need.

In other embodiments, the agentic orchestrator 100 may apply different decision criteria when determining whether to initiate a disambiguation workflow. For instance, the orchestrator 100 may be instructed to trigger disambiguation only when both (i) the query is determined to be vague and (ii) no document is deemed sufficiently relevant by the document relevancy module 130. Under such an implementation, disambiguation would not be performed if the query is sufficiently clear, or if at least one document is classified as highly relevant, even in cases where some degree of vagueness is detected. These examples are illustrative rather than limiting, and the agentic orchestrator 100 may alternatively employ other decision rules, weighting schemes, or reasoning strategies based on the outputs of the vagueness detection module 140, the document relevancy module 130, and additional contextual signals.

In certain embodiments, when the agentic orchestrator 100 determines that no query disambiguation is required, the orchestrator 100 initiates a standard retrieval-augmented generation (RAG) pipeline 150. In this implementation, any document identified as relevant by the document relevancy module 130 may be used to enrich the user query, irrespective of whether the vagueness detection module 140 indicates the presence or absence of vagueness. This approach reflects a design choice in which relevance is treated as sufficient to provide additional contextual grounding for answer generation.

In such a scenario, the agentic orchestrator 100 leverages the output of the document relevancy module 130 to extract pertinent contextual information from one or more relevant documents. This contextual information may include, for example, product-specific attributes, tenant-specific configurations, environment details, domain-specific terminology, or other metadata inferred from the relevant documents. The orchestrator 100 incorporates this information into an enriched version of the original user query, thereby producing a more informative query representation without requiring additional interaction with the user.

The enriched query is then provided as input to the standard RAG pipeline 150, which performs retrieval over the knowledge base and generates a response using a generative language model constrained by the retrieved context. Because the enrichment is derived from documents already determined to be relevant, the RAG pipeline 150 is able to generate a higher-precision response that is more closely aligned with the inferred scope of the user's inquiry.

In a further embodiment, if no disambiguation is required and the document relevancy module 130 does not identify any documents meeting a relevance threshold, the agentic orchestrator 100 may allow the standard RAG pipeline 150 to proceed without explicit query enrichment. In this case, the original user query is passed directly to the RAG pipeline 150, and the system relies on the retrieval and generation capabilities of that pipeline to produce a best-effort response based on available information. This flexible handling enables the system to avoid unnecessary clarification steps while still providing responsive and efficient question answering across a variety of query conditions.

In another scenario where the agentic orchestrator 100 determines that disambiguation is needed, it may initiate a query disambiguation flow. The goal of the disambiguation flow is to clarify the user's intent prior to final answer generation by selectively gathering contextual information and generating targeted follow-up questions. By refining the query at this stage, the system improves retrieval precision, reduces downstream ambiguity, and increases the likelihood that the final response accurately addresses the user's underlying problem.

To support effective disambiguation and to determine what follow-up question to generate, the QA system leverages content from multiple document sources, including a general knowledge base and a solution repository. The general knowledge base may contain a large and diverse collection of information. For example, when used in the technical support context, the general knowledge base may include technical documentation and articles that span multiple products, configurations, and use cases. These general documents are not specifically designed to provide particular solutions to common user problems. This breadth is useful for identifying different possible themes or interpretations of an ambiguous query. In contrast, the solution repository may contain a smaller set of curated, subject-matter-expert (SME) authored documents that describe end-to-end scenarios and troubleshooting steps for known problems (e.g., a solution playbook). Although limited in number, these solution documents are highly specific and authoritative, making them particularly valuable for guiding clarification when applicable.

In particular embodiments, the disambiguation flow includes a parallel or near-parallel retrieval step 160 in which the QA system retrieves documents from both the general knowledge base and the solution repository using the user query or an enriched version thereof. For example, the QA system may perform general document retrieval from the main knowledge base to retrieve a broad set of documents (e.g., top 50) using the original query. This captures a wide range of potentially related information. Due to their focused nature, a smaller set (e.g., top 10) is typically retrieved, relative to those retrieved from the general knowledge base. In particular embodiments, the retrieval may be based on the aforementioned precomputed question embeddings associated with each document.

After obtaining a set of general documents from the knowledge base and a set of solution documents from the solution repository, the QA system then performs a context analysis and refinement step, where the system decides whether to use solution documents or general documents for query disambiguation and/or follow-up generation (Step 165 in FIG. 1).

In particular embodiments, a relevance score is computed during retrieval for all documents against the input user query. In some implementations, the relevance score assigned to a document is based on vector similarities between an embedding representing the user query and the precomputed question embeddings associated with the document. In other implementations, an LLM may be employed to further evaluate and re-rank the relevancy of a document identified via embedding comparisons. In either approach, the final relevance score acts as an indicator to determine the relevance of the document to the query.

These relevance scores may then be used to determine whether to use a solution document or a general document for query disambiguation. In particular embodiments, the decision is based on comparing relevance scores: if the highest relevance score from a solution document exceeds that of general documents, the solution document is used. Otherwise, general documents will be used for disambiguation. This approach ensures that the most relevant and targeted source guides the disambiguation process. For example, the maximum relevance score achieved by a retrieved document from the solution repository is compared against the maximum relevance score from the general document retrieval. If a solution document exhibits a significantly high relevance score, indicating strong confidence that it directly addresses the (potentially vague) query's underlying need, this single solution document is selected. In this high-confidence scenario, all other retrieved solution documents and general documents are discarded. In other words, the selected solution document with the most relevance becomes the sole contextual input for the follow-up generation module.

When the solution document from the solution repository satisfies the selection criteria, the QA system uses it as the primary source of contextual information for disambiguation. In this scenario, the presence of an authoritative, end-to-end solution indicates that the user's query likely falls within a known problem space for which guided clarification can be derived directly from the solution content. As a result, the system bypasses broader analysis steps intended for large document sets, such as clustering across numerous general documents.

The content of the qualifying solution document (or documents, in some embodiments) is provided as contextual input to a large language model for follow-up question generation 190. The solution document may be tagged or otherwise identified as a distinct source so that differences between multiple solution documents, if present, are preserved. Using this context, the language model generates one or more targeted follow-up questions designed to resolve remaining ambiguity in the user's query in view of the qualifying solution document(s). For example, the follow-up questions may ask the user to confirm which specific product, configuration, or scenario described in the solution document applies to their situation. The generated follow-up question is then sent to the user's device 101. The user may then respond to the follow-up question, which will be processed by the agentic orchestrator 100, and the process will repeat in another iteration.

Because solution-repository documents are authored to cover complete scenarios and troubleshooting workflows, the follow-up questions generated from this content tend to be more precise and actionable than questions derived from general documentation alone. This approach allows the QA system to efficiently guide the user toward a clarified intent using authoritative domain knowledge, improving both the relevance of subsequent retrieval and the overall user experience. In addition, since it bypasses steps 170 and 180, it also improves system efficiency.

In an alternative scenario, when the disambiguation flow is initiated and no document from the solution repository satisfies a predefined relevance criterion (e.g., fails to meet a threshold relevance score), the QA system proceeds using documents retrieved from the general knowledge base. This scenario typically arises when the user's query corresponds to a broad or ill-defined problem space for which no single end-to-end solution document is available, or when the query spans multiple products, configurations, or domains covered across numerous technical documents.

Returning to step 165, if the system determines that no solution document satisfies the threshold criteria, then the QA system will proceed with using the larger set of retrieved general documents (e.g., the top 50) to extract the most relevant information for disambiguation and/or follow-up generation. In particular embodiments, the QA system may perform a filtering process on the retrieved general documents. Basic filtering may be applied to remove highly redundant or near-duplicate documents within each set to ensure contextual diversity. This filtering may be based on, e.g., analyzing URL patterns and/or a text-similarly comparison. Reducing redundancy and narrowing the document set improves efficient downstream processing. It is worth noting that in particular embodiments, the QA system does not perform a relevance filter at this stage to preserve diversity in the topics and themes covered by the documents. Since the documents are intended to help disambiguate the query, it may be preferable to retain breadth of the documents instead of narrowing it down for depth. This helps to find more relevant documents for an ambiguous query which might need continuous iterative search and intent clarification.

Because general documents may have overlapping content not caught by heuristics—especially when authored by different internal teams—a dynamic clustering approach (e.g., with 2-10 clusters) may be used to identify and group similar documents (step 170). Within each cluster, relevant segments are extracted, and an LLM summarizes the theme of the cluster (step 180). The LLM then ranks clusters based on the relevance of their thematic summaries to the query, selecting only the most relevant few (e.g., top 3 out of 10) for further processing. This streamlines the dataset while preserving contextually rich information for subsequent disambiguation and/or follow-up generation steps. Further details about an embodiment of this process are outlined below.

At the Pre-generated Questions Clustering phase (block 170), the QA system may first cluster the retrieved general documents. An efficient clustering algorithm (e.g., Faiss, ScaNN) may be applied to cluster the general documents. The clustering algorithm may be configured to group the documents into an optimal number of clusters within a defined range (e.g., 2 to 10) by the types of questions they can answer. In certain embodiments, the clustering algorithm is not applied to the document or a corresponding document embedding themselves, but to the embeddings of the pre-generated questions associated with these retrieved documents. As previously mentions, the embedding associated with each document is a numerical vector representation of the pre-generated questions associated with that document. Since the embeddings for the pre-generated questions were generated offline before system deployment, the QA system does not have to spend time generating those embeddings. Instead, the clustering algorithm could simply retrieve those embeddings from storage and perform clustering directly.

At the thematic summarization step 180, for each document within each cluster, the most relevant text segment(s) pertaining to the original user query may be extracted. In particular embodiments, an LLM prompt is then used to process this information per cluster. The LLM may receive as input the user query, cluster identifier, list of the most relevant segment from each document within that cluster. Instead of passing entire documents to the LLM, only the most relevant segments from each document are included to avoid overwhelming the model and to prevent the “lost in the middle” issue. These segments are grouped by dynamically assigned cluster numbers, and each cluster in the prompt contains a list of its associated relevant segments, enabling more efficient and focused reasoning by the LLM. The LLM may be prompted to (1) generate a concise summary characterizing the theme of each cluster based on its segments and (2) rank the clusters by their overall relevance to the user query. This process effectively filters out documents that were retrieved based on keyword or syntactic matches and identifies the core thematic areas relevant to the vague query.

From each cluster deemed relevant (e.g., the highest ranked two, three, or four clusters out of ten total clusters), the single document with the highest relevance score with the user query is selected as the representative for that theme/cluster. The relevant segment(s) and associated pre-generated questions for these representative documents form the contextual input for disambiguation and/or follow-up query generation step 190.

The clustering process described above has several benefits. It reduces redundancy by grouping similar documents together rather than treating them individually, and it enables re-ranking based on thematic relevance. This organization helps the LLM process more efficiently by providing contextual clusters of relevant segments, leading to more informed and accurate query disambiguation. In addition, clustering improves system efficiency by reducing the LLM's search space by grouping similar documents together and reducing redundancy, while at the same time maintaining the query relevance for already ranked documents. In addition, assigning human-readable labels to each cluster adds a valuable reasoning step for the LLM and allows for easier validation and interpretation by humans, improving both output quality and oversight.

It is worth noting that in certain embodiments, the clustering process described above is only applied to the general documents but not documents from the solution repository. Since solution documents are limited in number (usually fewer than 10) and each is highly focused on a specific topic or product, there's minimal overlap between them. Typically, only one or two documents have high relevance to a query. Because each solution document is self-contained and comprehensive, clustering or segmenting them add little value. Thus, instead of expending resources on clustering, the QA system uses the full content of the most relevant solution document for query disambiguation, as the entire document is likely relevant.

At the follow-up question generation step 190, the system generates one or more clarifying questions intended to refine the user's query based on contextual information obtained during prior stages of the disambiguation flow. Depending on the retrieval outcome, this contextual information may be derived from one or more solution-repository documents or from selected documents retrieved from the general knowledge base. In particular embodiments, a large language model (LLM) is prompted to generate the follow-up questions using the original user query in combination with the retrieved context. For example, when a solution document is identified, the prompt input may include content from the relevant solution document. When general knowledge base documents are used, the prompt input may include representative document segments selected after clustering, along with associated pre-generated questions or thematic summaries derived therefrom. This contextual grounding enables the LLM to generate targeted follow-up questions that address specific ambiguities in the user's query.

In certain example implementations, the system employs a prompting strategy commonly referred to as an ECHO prompt to encourage the LLM to explore multiple plausible interpretations of the user's query in view of the provided context. The ECHO prompt may instruct the LLM to restate, vary, or reinterpret the query using contextual signals drawn from the retrieved documents, thereby surfacing different facets or meanings that may be relevant. While the ECHO prompting approach is useful for generating diverse interpretations, it may not, by itself, sufficiently capture all dependencies or contextual nuances present in more complex queries. Accordingly, in some embodiments, the ECHO prompt is combined with additional reasoning instructions to improve completeness and robustness.

In particular embodiments, a chain-of-thought style prompting technique is used in conjunction with, or as an alternative to, the ECHO prompt. Under this approach, the LLM is instructed to reason step-by-step over the user query and the contextual information, breaking down the query into refined sub-questions or candidate interpretations. This reasoning process may be performed iteratively, with the LLM evaluating whether the available context sufficiently resolves the user's intent or whether additional clarification is required. During each iteration, the model rephrases the query based on context, analyzes variability and specificity across documents, and assesses whether disambiguation is necessary by assigning a confidence score. The score may indicate that disambiguation of the query is needed given the context, or that the query is already clear (i.e., disambiguation is not needed) or that no document sufficiently answers it (i.e., disambiguation would not help).

In embodiments where the QA system is deployed in a particular troubleshooting domain, certain constraints may be added to help guide the LLM. For example, in the network security domain, the QA system may anticipate that a user query may pertain to a general network construct or configuration entity type (e.g., “tunnel,” “peer,” “policy rule,” “address object,” “security profile”) but lacks the specific name/identifier. As such, the QA system may be configured such that, upon determining that follow-up questions are necessary, then one of the generated questions must explicitly ask the user to provide the specific name or identifier (e.g., “What is the specific name of the tunnel/peer/policy you are asking about?”). This may be added as a constraint to the prompt forcing it to generate a query of this form if not already mentioned in the query.

Using the aforementioned techniques and constraints, the LLM prompt is designed to produce, in particular embodiments: (i) a Vagueness Confidence Score: a numerical score (e.g., 0-100), where a higher score indicates lower perceived vagueness (i.e., higher confidence that the query might be answerable with current context); and (ii) Follow-up Questions: a list of 0 to N questions (if 0 question is generated, it means that the query does not need disambiguation). In particular embodiments, the LLM may further be prompted to generate a Reasoning Summary that explains the LLM's analysis of the context and query vagueness. This would help the user/admin understand the LLM's reasoning.

In particular embodiments, based on the output of the LLM described above, the system may then determine what to generate and display to the user. In particular embodiments, the generation logic may include a confidence threshold: if the confidence score is above, e.g., 90 or above, the system assumes the query is sufficiently clear and avoids follow-up questions to prevent overwhelming the user. In this case, the QA system will perform the standard process to obtain an answer to the query from the retrieved documents (e.g., via the RAG pipeline 150).

If the Confidence Score is below the threshold (e.g., <90), the LLM-generated follow-up questions, tailored to address the specific ambiguities or variations identified in the context, may be sent to the user device 101. The number of questions may vary (e.g., between 1 to 3). In particular embodiments, the number of questions presented may reflect the diversity of potential interpretations or missing information. When the user responds, the response may again be processed by the agentic orchestrator 100, and the process will repeat.

In certain embodiments, the system enforces a rule that limits the number of follow-up questions generated during a query disambiguation process in order to prevent indefinite clarification loops and to ensure timely progression to answer generation. In particular, when the agentic orchestrator 100 determines that query disambiguation is required and initiates a clarification interaction with the user, the orchestrator 100 restricts the number of disambiguation iterations to a predefined maximum, such as three follow-up question turns.

Each iteration corresponds to the agentic orchestrator 100 generating a targeted clarifying question, receiving a corresponding user response, and reassessing whether sufficient information has been obtained to resolve the user's intent. The system tracks the number of disambiguation turns associated with a given conversation thread using the multiturn memory bank 110, which maintains state information specific to that thread. By associating follow-up questions with a particular thread rather than with unrelated user inputs, the system ensures that the iteration limit is applied only to clarification efforts related to the same underlying query.

If, at any point before the iteration limit is reached, the agentic orchestrator 100 determines—based on updated signals from the vagueness detection module 140, the document relevancy module 130, or the accumulated user responses—that sufficient context has been obtained, the orchestrator 100 terminates the disambiguation process early and proceeds to trigger the RAG pipeline 150. In doing so, the agentic orchestrator 100 may combine or otherwise incorporate the user's responses from the clarification turns to form an enriched query representation for final retrieval and answer generation.

Conversely, if the predefined maximum number of follow-up questions is reached without resolving the ambiguity, the agentic orchestrator 100 concludes that further clarification is unlikely to be productive. In such cases, rather than continuing to prompt the user, the orchestrator 100 abandons the disambiguation workflow and falls back to the standard RAG pipeline 150. The system may then generate a best-effort response based on the original query and any information gathered during the clarification turns, thereby avoiding excessive latency or user frustration associated with prolonged questioning.

This iteration-limiting rule provides a deterministic safeguard against endless follow-up interactions while preserving the benefits of multi-turn clarification. By balancing adaptive disambiguation with a bounded interaction strategy, the system improves robustness, predictability, and overall user experience in agentic question answering environments.

In particular embodiments, to support complex, multi-turn interactions during query disambiguation, the agentic orchestrator 100 utilizes a multi-turn memory bank 110 that persists conversational state across successive interactions with the user. The multi-turn memory bank 110 enables the system to maintain continuity, reduce redundancy, and progressively refine the user's intent into a high-precision query suitable for final answer generation.

In particular embodiments, the multi-turn memory bank 110 stores contextual information associated with an ongoing conversation, including the original user query, any system-generated follow-up questions, and the corresponding user responses. This persistent storage allows the agentic orchestrator 100 to reference prior interaction turns when processing new input, ensuring that the system does not lose context when the user responds to clarifying questions or references earlier information.

The agentic orchestrator 100 consults the multi-turn memory bank 110 to prevent redundant interactions. For example, before generating a new follow-up question, the orchestrator 100 may check whether a similar question has already been posed and answered in a previous turn. By avoiding repeated or overlapping clarification requests, the system improves efficiency and enhances the user experience.

Once one or more follow-up questions have been generated and presented to the user, the agentic orchestrator 100 may determine that sufficient contextual information has been obtained. The agentic orchestrator 100 may then synthesize the full memory state associated with the user's session stored in the multi-turn memory bank 110, including the original query, the system's clarifying follow-up questions, and the user's answers. Using this aggregated context, the agentic orchestrator 100 synthesizes a single, coherent, and significantly more specific query that reflects the clarified user intent. This refined, context-enriched query is then provided to the RAG pipeline 165 to generate a final response to the user's original query.

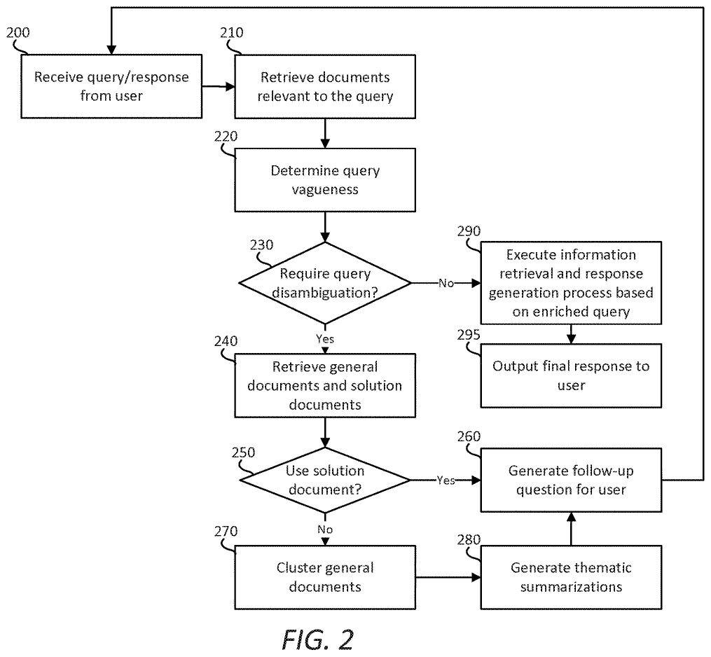

FIG. 2 is a flow diagram illustrating an example computer-implemented method for query disambiguation and response generation. At step 200, a computing system receives a query from a user, such as a natural-language request submitted via a user interface. At step 210, the computing system retrieves one or more relevant documents responsive to the query. In certain embodiments, each relevant document is retrieved using pre-computed embeddings of questions associated with that document, where the embeddings are generated prior to receiving the query from the user, thereby enabling efficient semantic matching.

At step 220, the computing system determines a degree of query vagueness based on one or more ambiguity signals. These ambiguity signals may include, for example, a length of the query or an absence of domain-specific identifiers, such as product identifiers or error codes. In some embodiments, the retrieval of relevant documents at step 210 and the determination of query vagueness at step 220 are performed as tools invoked by a large language model in response to the received query. In particular embodiments, the two tools my execute in parallel.

At step 230, the computing system determines, by the large language model, whether the query requires disambiguation based on the determined query vagueness and the relevant documents retrieved at step 210.

In one scenario,, the computing system may determine, based on the query vagueness and the relevant documents retrieved at step 210, that the query does not require disambiguation. This determination indicates that the user's intent is sufficiently clear and that additional clarification through follow-up questioning would not materially improve response accuracy.

In this case, the system proceeds directly to an information retrieval and response generation flow at step 290. The response generation flow may include a retrieval-augmented generation (RAG) process or another retrieval-based response generation technique. As part of this flow, the computing system retrieves contextual information from one or more knowledge sources using the original query, or an optionally enriched version thereof, and generates a response based on the retrieved contextual information. For example, the system may augment the query with inferred product identifiers, domain-specific terminology, configuration details, or other contextual attributes extracted from the retrieved documents. This enrichment is performed without requesting additional input from the user and is intended to streamline retrieval and improve answer precision when sufficient context is already available.

At step 295, the final response generated by the response generation flow is provided to the user. The response is based on the retrieved contextual information and reflects the system's determination that the original query, with or without optional enrichment, was sufficiently clear to support accurate answer generation without engaging in a disambiguation workflow.

Returning to step 230, another scenario may involve the computing system determining that disambiguation is required. In response to determining that disambiguation is required, the method proceeds to step 240, where the computing system retrieves, based on the query, a set of first documents from a general knowledge base and a set of second documents from a solution repository. In certain embodiments, the solution repository includes documents describing end-to-end troubleshooting guidance for known problem scenarios. In some embodiments, each document in both the set of first documents and the set of second documents is retrieved using pre-computed embeddings of questions associated with that document, with the embeddings having been generated prior to receipt of the user query.

At step 250, the computing system determines whether any second document from the solution repository satisfies a relevancy criterion for the query, such as a similarity threshold indicating strong semantic alignment.

In one scenario, the computing system determines that at least one solution document from the solution repository satisfies the relevancy threshold criterion for the query. This determination indicates that the user's query is strongly aligned with a known, end-to-end scenario addressed by the solution document, and that authoritative contextual guidance is available without requiring broader thematic exploration.

In this scenario, the system bypasses the clustering step 270 and the thematic summarization step 280. Because solution documents in the solution repository are authored to provide comprehensive, cohesive coverage of specific troubleshooting or resolution workflows, additional clustering across general knowledge base documents is unnecessary. Instead, the identified solution document is treated as a primary source of contextual information for disambiguation.

The computing system uses the content of the solution document directly to generate one or more follow-up questions configured to clarify the user's query. This is shown in FIG. 2 by the arrow pointing to step 260. In particular embodiments, the entire solution document or relevant segments of the solution document, along with associated predefined questions or structured guidance contained therein, are provided as input to a large language model. The large language model generates follow-up questions that are narrowly tailored to the scenarios, configurations, or decision points described in the solution document, thereby enabling precise clarification of the user's intent. The generated follow-up question is then presented to the user, and the method proceeds to receive the user's response at step 200, and the process iterates. The iteration is described further below.

Returning to step 250, another scenario is when the system determines that no second document satisfies the relevancy criterion. In response, the method proceeds to step 270, where the computing system determines clusters of first documents from the set of first documents retrieved from the general knowledge base. In certain embodiments, the clusters are determined based on pre-computed embeddings associated with the first documents, grouping together documents that reflect similar themes or interpretations of the query.

At step 280, the computing system generates a thematic summarization for each cluster of first documents. In particular embodiments, generating the thematic summarization includes identifying segments in the first documents of each cluster that are relevant to the query and generating the thematic summarization based on the identified segments. The computing system may select at least one cluster from the clusters of first documents based on the thematic summarization of the cluster.

Based on the selected cluster, the computing system generates, at step 260, a follow-up question configured to clarify the query. In certain embodiments, generating the follow-up question includes selecting at least one first document in the selected cluster and invoking the large language model to generate the follow-up question based on relevant segments in the selected document, predetermined questions associated with the document, and the original query. In some embodiments, the large language model is instructed to perform a chain-of-thought operation and/or ECHO prompts when generating the follow-up question. The follow-up question(s) is then displayed to the user.

Following receipt of the user response to the follow-up question, the method returns to step 200, and the process shown in FIG. 2 repeats to evaluate the user's response and determines whether additional follow-up questions are needed for disambiguation.

Following receipt of a user response to a follow-up question, the method may iteratively repeat the process illustrated in FIG. 2 to further evaluate and refine the user's intent. In particular, after receiving the user response, the method returns to step 200, where the response is treated as an updated query or as additional contextual input associated with the original query. The computing system then repeats the steps of retrieving relevant documents, analyzing query vagueness, and determining whether disambiguation is required, taking into account the additional context and clarity provided by the user's response.

In certain embodiments, the user's responses to one or more follow-up questions are aggregated with the original query to form a progressively refined understanding of the user's intent. This aggregated information is carried forward through each subsequent iteration of the process, such that the determination at step 230 reflects not only the initial query but also the accumulated clarifying information provided by the user. Based on this evaluation, the system determines whether additional follow-up questions are needed to resolve remaining ambiguity or whether the query is sufficiently clear.

This iterative process may continue over multiple interaction turns, with each iteration potentially generating an additional follow-up question and receiving a corresponding user response. The iterations proceed until either the system determines that the query no longer requires disambiguation, in which case the method advances to step 290 to invoke the information retrieval and response generation pipeline, or until a terminating condition is met. A terminating condition may include, for example, reaching a predefined maximum number of disambiguation iterations, after which the system ceases generating further follow-up questions and proceeds with response generation using the best available enriched query. In this manner, the method balances iterative clarification with bounded execution to efficiently converge on a clear user intent.

At step 290, the system generates an enriched query based on the original query and the responses to the follow-up questions. In some embodiments, the enriched query is generated using multiple responses to corresponding follow-up questions accumulated over multiple interaction turns with the user, with the system optionally limiting the number of follow-up question generation iterations to a predefined maximum to prevent indefinite clarification. Then, the computing system invokes a response generation pipeline that retrieves contextual information using the enriched query and generates a final response to the query based on the retrieved contextual information.

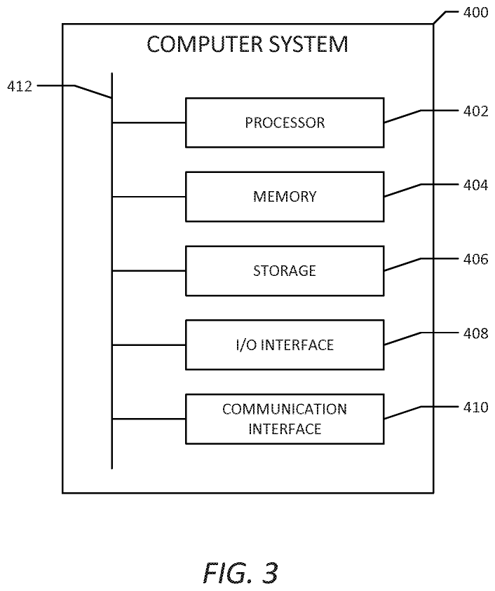

FIG. 3 illustrates an example computing system 400 that may be utilized to implement, execute, support, enable, or otherwise perform any aspect of the systems, methods, operations, algorithms, modules, or functionalities described herein. The computing system 400 is provided solely as one non-limiting example, and nothing in this description should be interpreted as requiring that any particular feature, component, or architectural arrangement be present unless explicitly recited in the claims. A person of ordinary skill in the art will understand that the disclosed embodiments may be realized using other suitable computing architectures, physical hardware configurations, virtualized or cloud-based infrastructures, distributed systems, edge computing nodes, embedded control platforms, or combinations thereof.

As shown in FIG. 3, the computing system 400 may include at least one processor 402, a memory 404, a storage device 406, an input/output (I/O) interface 408, and a communication interface 410, which may be interconnected through a bus 412 or any other suitable communication mechanism. Although FIG. 4 depicts a particular arrangement of components, the illustrated configuration is merely exemplary and not limiting; the computing system 400 may omit components, include additional components, substitute components, or integrate certain components into a system on chip architecture.

The processor 402 may include any suitable computing element capable of executing instructions, performing calculations, or controlling other components. The processor 402 may include, without limitation, a central processing unit (CPU), multicore processor, superscalar processor, graphics processing unit (GPU), tensor processing unit (TPU), neural processing unit (NPU), digital signal processor (DSP), microcontroller (MCU), system on chip (SoC) processor, application specific integrated circuit (ASIC), field programmable gate array (FPGA), vector processor, co-processor, or any combination thereof. In various embodiments, processor 402 may include heterogeneous compute units, reconfigurable logic, or dedicated accelerators designed to support artificial intelligence, machine learning (ML), cryptographic operations, distributed consensus algorithms, robotics control, multimedia processing, or other specialized computational workloads. No particular processor technology or architecture is required unless explicitly stated in the claims.

The memory 404 may include volatile, non-volatile, static, dynamic, persistent, temporary, removable, or any other type of memory. Examples include DRAM, SDRAM, DDR type memory, SRAM, cache memory, register files, embedded memory, flash memory, NVRAM, MRAM, phase change memory (PCM), optical memory, or any combination thereof. Memory 404 may store program instructions, execution environments, data structures, inference tensors, feature maps, intermediate outputs of ML models, sensor measurements, firmware images, kernel modules, or other machine-readable information. Unless stated otherwise, the term “memory” encompasses single device, multi device, distributed, or hierarchical memory systems.

The storage device 406 may include any non-volatile storage medium or storage subsystem, including local storage, remote storage, distributed storage, or cloud-based storage services. Examples include solid state drives (SSD), NVMe devices, hard disk drives (HDD), RAID arrays, flash memory devices, optical media, magnetic media, object stores, distributed file systems, or persistent network attached storage (NAS). Storage 406 may hold training datasets, AI/ML model parameters, inference engines, configuration files, logs, application containers, virtual machine images, databases, or other digital artifacts. The specific type or form of storage is not limiting unless explicitly recited.

The input/output interface 408 may support communication with any type of peripheral, sensor, actuator, display, or user interaction device. Examples of peripheral devices include monitors, projectors, touchscreens, keyboards, mice, haptic devices, cameras, microphones, speakers, head mounted displays, and augmented or virtual reality interfaces. In embedded, industrial, or robotic contexts, the I/O interface 408 may include GPIO, SPI, I²C, UART, CAN bus, LIN bus, PWM channels, analog to digital converters (ADCs), digital to analog converters (DACs), servo controllers, or motor drivers. The I/O interface 408 may also interface with external computing elements, including sensors (e.g., accelerometers, gyroscopes, magnetometers, LiDAR, radar, depth sensors, environmental sensors), actuators, or other hardware modules.

The communication interface 410 may permit the computing system 400 to communicate with external devices, systems, networks, or services using any wired or wireless communication technologies. Wired communication may include Ethernet (at any speed), USB, USB C, Thunderbolt, PCI Express, serial interfaces, or automotive/industrial buses. Wireless communication may include Wi Fi (any IEEE 802.11 variant), Bluetooth, BLE, NFC, Zigbee, Z Wave, ultra wideband (UWB), satellite communication, or cellular technologies (3G, 4G/LTE, 5G NR, and future evolutions). In distributed or cloud environments, communication interface 410 may also support high performance interconnects such as InfiniBand, NVLink, RDMA, or custom fabrics enabling distributed training of machine learning models, parallel computation across nodes, federated learning, or multi device coordination. No particular communication protocol, medium, or topology is required to practice the claimed subject matter unless explicitly stated.

The bus 412 may represent any interconnect or communication fabric, including a traditional system bus, a high-speed point to point link, an AMBA or AXI bus, PCIe links, a network on chip (NoC), parallel bus architecture, switched fabric, or any proprietary or standard communication architecture. The bus 412 may facilitate communication among processor 402, memory 404, storage 406, I/O interface 408, communication interface 410, and any other components that may be present in various implementations.

During operation, the computing system 400 may execute instructions stored in memory 404 or storage 406 to perform any of the functions described herein. The software executed by the computing system may include compiled code, interpreted code, firmware, middleware, machine learning models, neural network inference engines, containerized microservices, virtual machine workloads, real time control loops, or any other form of machine executable instructions. The computing system 400 may operate as a standalone device, part of a distributed system, an on-premise server, a cloud-based service, an edge computing node, or an embedded controller. In AI/ML contexts, the computing system 400 may perform model training, inference, feature extraction, sensor fusion, distributed gradient computation, federated learning aggregation, or related operations. In embedded contexts, the computing system may provide hardware level control, real time signal processing, or deterministic task scheduling. Unless expressly stated, no particular execution mode, software architecture, hardware configuration, or operating environment is required to practice the claimed subject matter.

Finally, a person of ordinary skill in the art will recognize that the computing system 400 is merely one possible implementation and is not intended to limit the scope of the claimed invention. Any computing arrangement capable of executing instructions or performing the described methods—whether now known or later developed—may be used without departing from the spirit or scope of the present disclosure.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate. The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

While the invention has been illustrated and described in detail in the drawings and foregoing description, such illustrations and descriptions are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

Numerical ranges recited in this application should be construed to be inclusive of the end points of the stated ranges. Particular axes, such as one or more lateral and/or longitudinal axes, which may be omitted herein in some illustrations, should be construed to exist in every illustration or situation where it is referred to.

1. A method comprising, by a computing system:
receiving a query from a user;
retrieving relevant documents to the query;
determining a query vagueness of the query based on one or more ambiguity signals;
determining, by a large language model, whether the query requires disambiguation based on the query vagueness and the relevant documents;
in response to determining that the query requires disambiguation, retrieving, based on the query, (i) a set of first documents from a general knowledge base and (ii) a set of second documents from a solution repository;
determining whether any second document in the set of second documents satisfies a relevancy criterion for the query;
in response to a determination that the set of second documents fails to satisfy the relevancy criterion, determining clusters of first documents from the set of first documents;
generating a thematic summarization of each of the clusters of first documents;
selecting at least one cluster from the clusters of first documents based on the thematic summarization of the cluster;
generating, based on the at least one cluster, a follow-up question configured to clarify the query;
receiving a response to the follow-up question from the user;
generating an enriched query based on the query and the response to the follow-up question; and
invoking a response generation pipeline that retrieves contextual information using the enriched query and generates a final response to the query based on the retrieved contextual information.

2. The method of claim 1, wherein each of the relevant documents is retrieved based on pre-computed embeddings of questions associated with the relevant document, the pre-computed embeddings being generated prior to receiving the query from the user.

3. The method of claim 1, wherein the one or more ambiguity signals are determined based on at least one of a query length or absence of domain-specific identifiers.

4. The method of claim 1, wherein the retrieving of the relevant documents and the determining of the query vagueness are tools invoked by the large language model in response to the query.

5. The method of claim 1, wherein the solution repository comprises documents describing end-to-end troubleshooting guidance.

6. The method of claim 1, wherein each document in the (i) set of first documents and (ii) the set of second documents is retrieved based on pre-computed embeddings of questions associated with that document, the pre-computed embeddings being generated prior to receiving the query from the user.

7. The method of claim 1, wherein the clusters of first documents are determined based on pre-computed embeddings associated with the set of first documents.

8. The method of claim 1, wherein generating the thematic summarization of each cluster in the clusters of first documents comprises:
identifying segments in the first documents in the cluster that are relevant to the query; and
generating the thematic summarization based on the segments.

9. The method of claim 1, wherein generating the follow-up question comprises:
selecting at least one first document in the at least one cluster; and
invoking the large language model to generate the follow-up question based on at least (i) segments in the at least one first document that are relevant to the query, (ii) predetermined questions associated with the at least one first document, and (iii) the query.

10. The method of claim 1, wherein the enriched query is generated using one or more additional responses to one or more corresponding follow-up questions accumulated over multiple interaction turns with the user.

11. The method of claim 1, further comprising limiting a number of follow-up question generation iterations to a predefined maximum.

12. The method of claim 1, wherein the follow-up question is generated using the large language model instructed to perform a chain-of-thought operation.

13. A method comprising, by a computing system:
receiving a query from a user;
retrieving relevant documents to the query;
determining a query vagueness of the query based on one or more ambiguity signals;
determining, by a large language model, whether the query requires disambiguation based on the query vagueness and the relevant documents;
in response to determining that the query requires disambiguation, retrieving, based on the query, (i) a set of first documents from a general knowledge base and (ii) a set of second documents from a solution repository;
determining whether any second document in the set of second documents satisfies a relevancy criterion for the query;
in response to a determination that a second document in the set of second documents satisfies the relevancy criterion, generating, based on the second document, a follow-up question configured to clarify the query;
receiving a response to the follow-up question from the user;
generating an enriched query based on the query and the response to the follow-up question; and
invoking a response generation pipeline that retrieves contextual information using the enriched query and generates a final response to the query based on the retrieved contextual information.

14. The method of claim 13, wherein each of the relevant documents is retrieved based on pre-computed embeddings of questions associated with the relevant document, the pre-computed embeddings being generated prior to receiving the query from the user.

15. The method of claim 13, wherein the one or more ambiguity signals are determined based on at least one of a query length or absence of domain-specific identifiers.

16. The method of claim 13, wherein the solution repository comprises documents describing end-to-end troubleshooting guidance.

17. A system comprising:
one or more processors;
a memory storing instructions that, when executed by the one or more processors, cause the system to:
receive a query from a user;
retrieve relevant documents to the query;
determine a query vagueness of the query based on one or more ambiguity signals;
determine, by a large language model, whether the query requires disambiguation based on the query vagueness and the relevant documents;
in response to a determination that the query requires disambiguation, retrieve, based on the query, (i) a set of first documents from a general knowledge base and (ii) a set of second documents from a solution repository;
determine whether any second document in the set of second documents satisfies a relevancy criterion for the query;
in response to a determination that the set of second documents fails to satisfy the relevancy criterion, determine clusters of first documents from the set of first documents;
generate a thematic summarization of each of the clusters of first documents;
select at least one cluster from the clusters of first documents based on the thematic summarization of the cluster;
generate, based on the at least one cluster, a follow-up question configured to clarify the query;
receive a response to the follow-up question from the user;
generate an enriched query based on the query and the response to the follow-up question; and
invoke a response generation pipeline that retrieves contextual information using the enriched query and generates a final response to the query based on the retrieved contextual information.

18. The system of claim 17, wherein each document in (i) the set of first documents and (ii) the set of second documents is retrieved based on pre-computed embeddings of questions associated with that document, the pre-computed embeddings being generated prior to receiving the query from the user.

19. The system of claim 17, wherein the instructions, when executed by the one or more processors, are configured to cause the system to generate the thematic summarization of each cluster in the clusters of first documents by:
identifying segments in the first documents in the cluster that are relevant to the query; and
generating the thematic summarization based on the segments.

20. The system of claim 17, wherein the instructions, when executed by the one or more processors, are configured to cause the system to generate the follow-up question by:
selecting at least one first document in the at least one cluster; and
invoking the large language model to generate the follow-up question based on at least (i) segments in the at least one first document that are relevant to the query, (ii) predetermined questions associated with the at least one first document, and (iii) the query.
